(19) United States
(12) Patent Application Publication
(10) Pub. No.: US 2005/0248815 A1
(43) Pub. Date: Nov. 10, 2005

(54) Method for simple user driven one touch calibration of scanner and software therefor

(75) Inventor: Ron van Os, Morrison, CO (US)

Correspondence Address: Ron van Os, 8016 So Deer Creek Canyon Rd, Morrison, CO, 80465, US

(73) Assignee: Visioneer, Inc.

(21) Appl. No.: 10/838,364

(22) Filed: May 5, 2004

(51) Int. Cl. G06F 15/00

(52) U.S. Cl. 358/504

(57) ABSTRACT

The invention relates to a simple “one click” method for a User to calibrate their standard scanner or related device wherein a color target is inserted into the scanner and the User selects calibration initiation by clicking a single time on an icon as provided in the inventive method's user interface. A proprietary algorithm performs acquisition and conversion steps wherein the result is optimal color representations as between the device and its manufacturer produced color coordinates. Such a method is simple and requires no knowledge of the calibration process, thereby enabling the least sophisticated computer user to periodically calibrate their scanner or device so as to compensate for natural degradation over time of the illuminant contained therein.

### SPECIFICATION

### FIELD

The invention relates to a simple one-step method that allows a User to automatically and periodically calibrate a scanner or related device by inserting an industry standard color target. The inventive method requires little input or skill from the User to perform a calibration, and yet optimizes the calibration process in a transparent but complex manner. Such calibration method is applicable throughout the life of a scanner or device containing a CCFL, CIS or standard fluorescent lamp, thereby ensuring consistent performance over the life of the device.

### BACKGROUND OF THE INVENTION

The invention most closely corresponds with USPTO Class 358/1.5 wherein Class 358 includes communication or reproduction of a static image or sequence of static images in which the local light, or density variations composing the image do not vary with time. The sub-class includes subject matter wherein the position or speed of the marking means or image medium modifies the presentation of the data.

In its simplest form, the invention comprises a method combining a software program with a physical color target to be inserted into an optical scanner or related device with the purpose of automatically calibrating the scanner or device for optimal color reproduction on a finished scan (for purposes of simplicity, the device most illustrated herein will be a standard scanner).

The calibration processes as exist prior to the invention are either mathematically cumbersome, are very error prone, or require multi-step processes that do not provide ease of scanner calibration to an unsophisticated computer user. Reference Bryn Mawr University, Triptych: The Tri-College Digital Library article on website URL http://triptych.brynmawr.edu/guides/scanner.html. Further reference to Automatic scanner calibration, Margaret Motamed, U.S. Pat. No. 6,327,047, indicates a current method of self calibration, but is limited to gray scale, and requires a target to be attached to a lead page of a scan as a “non-reflective sleeve located proximate to said scanning surface for holding said calibrated target thereto”. Additionally, the Motamed method does not include proprietary software, but rather relies on third party software. Further, the process in the Motamed patent indicates that the target runs with each scan and the User must address whether calibration each time is desired. Finally, the target in the above reference patent is required to be printed and subsequently processed through the scanner.

### THE INVENTION

Summary, Objects and Advantages

As is well known in the industry, a CCFL or standard fluorescent lamp degrades over time in terms of color temperature, uniformity, and light output. When this degradation occurs, a scanned image is affected as to the clarity and consistency of colors on images reproduced. The invention comprises in its broadest aspects, a new and unique method of utilizing a software program in combination with a standard color target with which a User may simply and automatically calibrate their own scanner. Periodic calibration will enable a User to obtain consistent and optimized results from their scanner over the life of the scanner, and thus eliminate the natural degradation in performance that results from an aging machine.

In a scanning process, the illuminant determines the actual color observed on a resulting scanned image. In the inventive method, the illuminant is assumed to be a CCFL or standard fluorescent lamp wherein the phosphor emits white light. All devices that are used in digital image manipulation like digital still cameras, video-cameras, scanners, monitors, video grabbers and printers each have their own transfer function or transmission characteristics. They alter the intensity distribution of the image data, some in a highly non-linear manner.

These alterations are often uncontrolled, causing severe problems when the images are viewed or manipulated using some other system than the one the images were created with. Too dark, too light or flat images are the most common indication of uncontrolled transfer characteristics. The hue-shift that is a direct consequence of non-linear transformations is too often left without any consideration.

The fact that the viewing gamma varies greatly between different computing platforms is also a consideration. The gamma corrections specific to a piece of hardware such as a scanner vary based upon the manufacturers, and most often it is not even specified, so one has to first measure the transfer characteristic before any calibration can be done. This is an anomaly of which unsophisticated Users are most definitely not aware, and one that requires even a sophisticated computer User to compensate for via complicated solutions.

The transfer function or linearity is the most important part of the color management. It is responsible for the too dark/light images and for hue-shifts e.g. if the orange looks as orange or as red. In the RGB (red, green, blue) mode that the monitors, scanners and cameras work there are given number of intensity levels for each primary color. In case of the common 3*8 bit=24 bit True-Color mode there are only 256 levels of intensity for each of the three primary colors. When mixed, these will make up all the other colors that are seen on the monitor, 256\hat{ }3=16, 7 Mil colors. If these 256 levels are not linearly calibrated then the whole color space (color gamut) is also un-calibrated and a high level graphics draftsperson would be quite unsatisfied with the output results. Most Users can be categorized as unsophisticated, and typically utilize a standard low to mid-price scanner. Such Users, if aware of calibration and its relevance to image quality at all, perform a visual calibration. Visual calibration involves multiple steps encompassing calibration of not only the scanner itself, but of the User's monitor and printer. This process is cumbersome and not particularly accurate.

The inventive method calibrates and compensates for the aforementioned characteristic issues in a simple “one click” process readily utilized by even the least sophisticated computer user. A User simply inserts a standard color target into their scanner and depresses the scan button. Here by way of example, we use a Kodak Q-60 target. The inventive user interface is launched and appears on the User's computer screen. The User then simply selects “acquire target” on the interface. During the acquisition, the scanner is placed in a known mode, the lamp stabilized, and the test target is scanned. Once the entire scan target is received by the inventive software, advanced pattern recognition is used to locate the crop marks inherent to the target to indicate the test area of the target. The target is scanned, and automatically cropped using a proprietary algorithm to place and locate crop marks on the appropriate area of the color target.

Inherent to the calibration process as detailed herein, there are two basic data sets. The first consists of color data as produced by a scanner, and the second is the color which is supposed to be produced based upon a test target. Utilizing coordinates on the color target, the inventive system identifies the location of each color square on the target, and subsequently compares the determined color to that of a manufacturer produced color coordinate for each square on the test target. This process occurs in seconds and is virtually transparent to the User.

The inventive algorithm is applied to this process of comparison to determine the best possible conversion of scanner produced data to resemble that of the test target. This conversion is then applied to each scan, and guarantees the color accuracy of the device. Included in the inventive user interface is also an option in the form of a drop down or slide scale menu item from which a User may choose to alter or customize the color gamma from lighter to darker if so desired.

In summary, the inventive method is a single step, one touch means for a User to calibrate their scanner in seconds, and without having particular skill or knowledge of the calibration process. The User simply inserts the color target, presses one button, and the process is conducted quickly and relatively transparent to that User. The market need for such a method is vast, and does not presently offer such a simple calibration solution to the typical computer user.

### BRIEF DESCRIPTION OF THE DRAWINGS

The invention is described in further detail by reference to the drawings in which:

FIG. 1; depicts a theoretical upper limit for bit-depth compression using the gamma function.

FIG. 2; is an industry standard color target as used for calibration.

FIG. 3; is a flow chart of the inventive method process for the entire calibration process.

FIG. 4; is a screenshot of the inventive method's user interface displaying an option to initiate calibration; and

FIG. 5; is a screenshot of the inventive method's user interface including a scanned color target and indicating gamma adjustment option.

### DETAILED DESCRIPTION, INCLUDING BEST MODES OF CARRYING OUT THE INVENTION

The following detailed description illustrates the invention by way of example, not by way of limitation of the principles of the invention. This description will clearly enable one skilled in the art to make and use the invention, and describes various embodiments, adaptations, variations, alternatives, and uses of the invention. The description includes what are presently believed to be the best modes of carrying out the invention.

In this regard, the invention is illustrated in five relatively simple figures; although sufficiently complex as to illuminate to one skilled in the art of such software architecture, programming, and computer operations a viable method for making or using said invention.

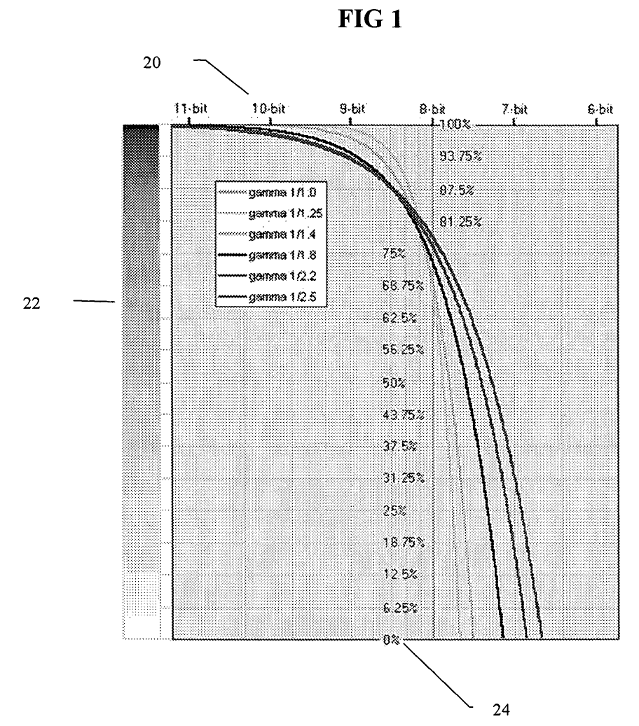

FIG. 1 is a graph indicating the theoretical upper limit for bit-depth compression using the gamma function at different values into 8-bit data. This Figure is primarily used to illuminate color gamma as organized data to aid in an understanding of functionality of gradients therein. For the mathematically inclined, the first derivative of the inverse gamma function, x-axis 20 is binary coded so that the value 1 of the derivative represents the 8-bit accuracy. Y-axis 22 is coded to show the gray percentage K %. Gamma compensation reduces accuracy in the range 0% to 75% black. For gamma spaces 2.2 and above only less than 7-bit accuracy is available in the highlights. For color images the 7-bit resolution is the same as color reduction by 8 times since each of the color components (red, green and blue) are cut in half. This is approximately the same quality that the JPG format holds using middle compression setting. Gamma compensation 24 gains accuracy in the range 75% to 100% black.

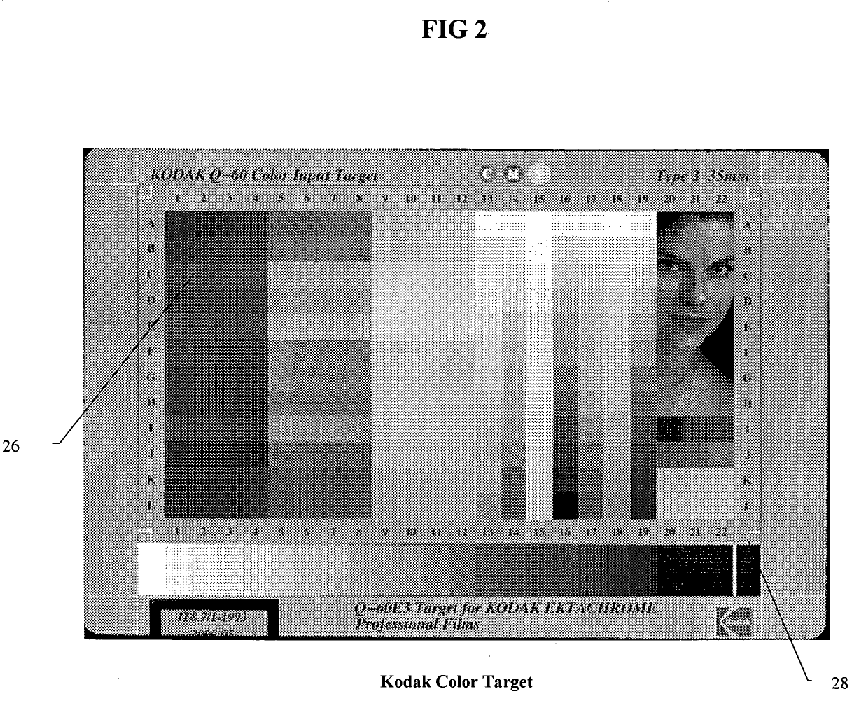

FIG. 2 is a representation of the Kodak Q-60 color target as being an example of an industry standard color target. This target is not meant to be protected under any patent consideration in this Application, and is displayed for clarification purposes only. Each individual color square 26 represents a target color. Crop marks 28 are inherent to the target, and are integral in aiding the inventive software in acquisition of a test area to exclude all other areas of the target. Once cropped, the target area within the crop marks is the only area used in the calibration process as related to each color square's coordinates. These coordinates will provide a base for the inventive method calibration's comparison and conversion.

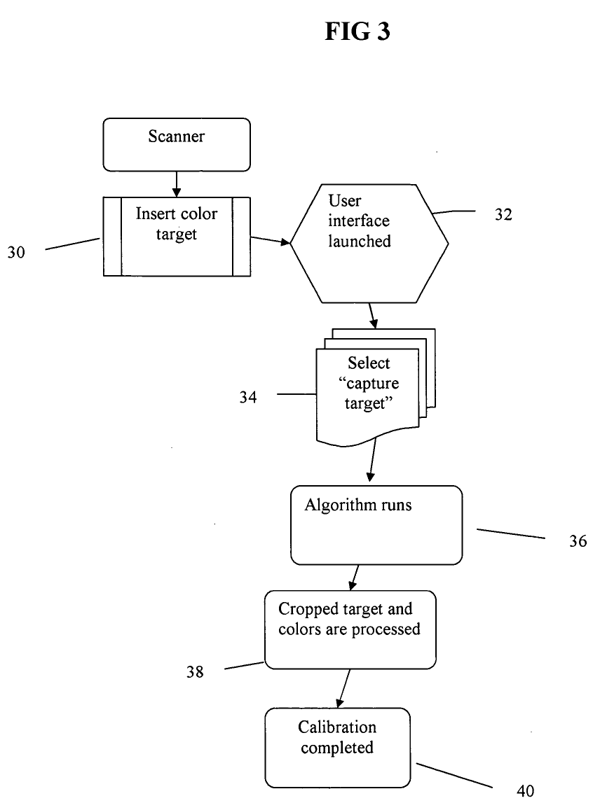

FIG. 3 is a flow chart illuminating the sequence of steps performed by the inventive method, beginning with insertion of the color target into the scanner 30. After insertion, the inventive user interface 32 is launched, and the User selects “acquire target” 34. Once acquired, the proprietary algorithm processes the target 36. During the algorithmic function, the crop marks as inherent to the color target are acquired 38 and the colors are processed and converted as to the best match with the device's manufacturer produced coordinates. Once acquisition, conversion, and color processing is complete, calibration has been performed 40.

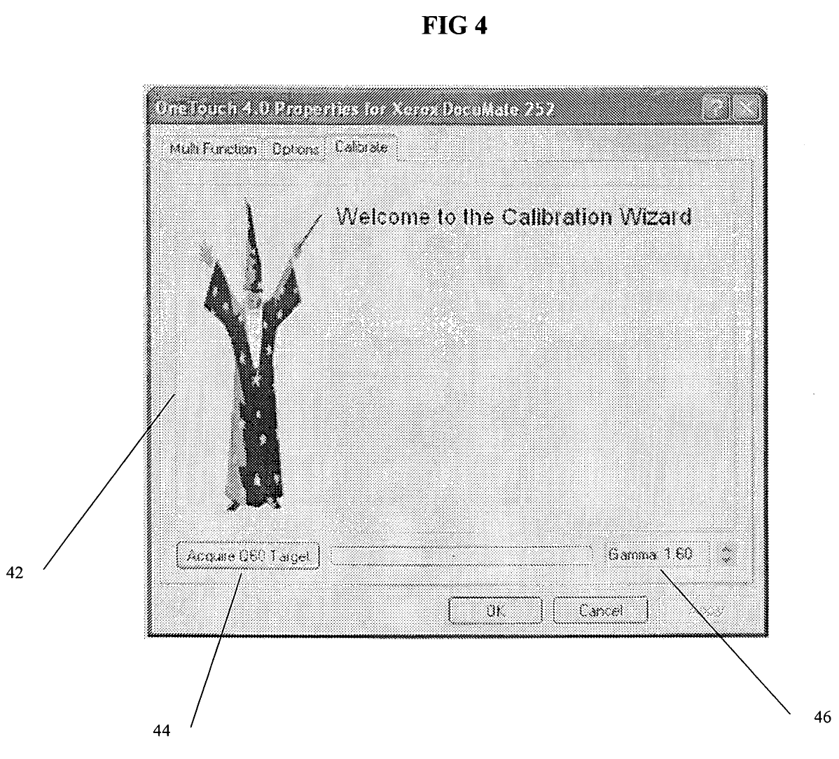

FIG. 4 represents the inventive method's user interface as displayed on a User's computer screen upon launch of the calibration software 42. included on the user interface are options for initiating the calibration by acquiring the color target, and adjusting the gamma if so desired. The “acquire target” button or icon 44 allows for a single click by the User to initiate capture of the target and includes the remaining steps of calibration without additional User input. Additionally, the User may adjust the color gamma if so desired by clicking the gamma option 46. This may be done so that a User can visually compare squares on the color target as displayed on their individual computer monitor. This option is one most likely chosen by a more sophisticated User.

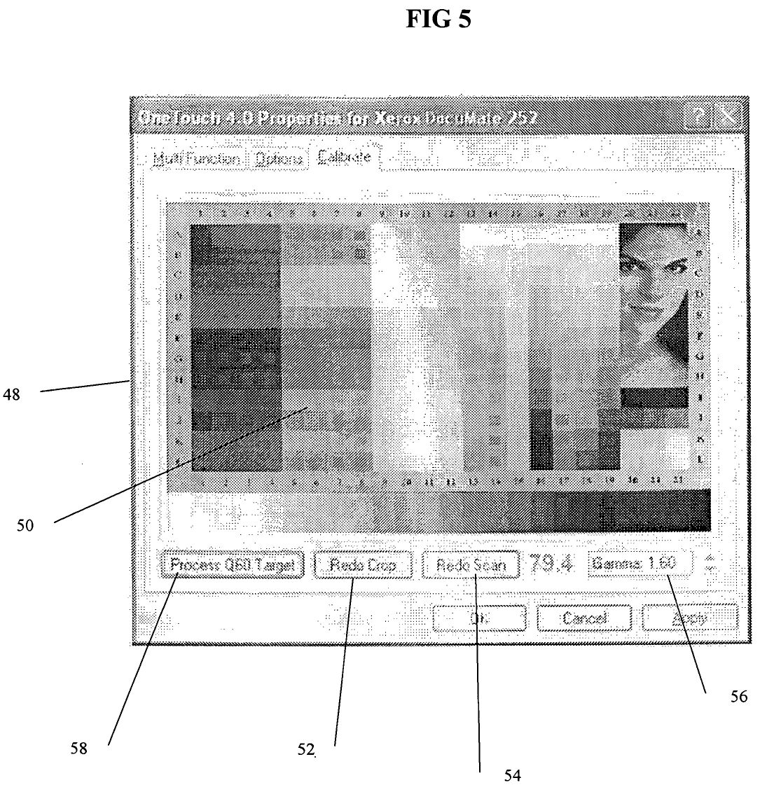

FIG. 5 illustrates the inventive software's user interface as appears once the color target has been acquired 48. The color target, as cropped, is displayed on the user interface 50, and contains the color squares as indicating the match that the inventive software has found upon calibration. Further choices are available to the User such as repeating the crop 52, repeating the scan 54, adjusting gamma 56, or processing the target 58. The steps in this stage of the User's view are in point of fact repetition of the calibration process as opposed to new tasks.

1) A method for simple one touch calibration of a standard scanner or related device which outputs color images utilizing a single step User interface and software therefor.

2) A method as in claim 1 wherein calibration is dependant upon insertion of a color target into said scanner or related device.

3) A computer program comprising proprietary algorithms to be applied to acquisition and conversion of colors on said target.

4) A computer program as in claim 3 wherein said acquisition is accomplished after crop marks on said color target are located to determine a calibration test area.

5) A computer program as in claim 4 further comprising a conversion algorithm to compare and optimize colors on said target as compared to said scanner or related device manufacturer produced color coordinates.

6) A computer program as in claim 3 further comprising display of a user interface wherein a User may make selections as to calibration options.

7) A method as in claim 6 wherein a selection method comprises an option for a User to initiate calibration by clicking on an interface icon.

8) A method as in claim 6 further comprising a selection method to increase or decrease color gamma.
